(19) United States
(12) Patent Application Publication
(10) Pub. No.: US 2016/0133077 A1
(43) Pub. Date: May 12, 2016

(54) POLLING SYSTEM WITH INTEGRATED REWARDS PROGRAM

(71) Applicant: Richard Postrel, Miami Beach, FL (US)

(72) Inventor: Richard Postrel, Miami Beach, FL (US)

(21) Appl. No.: 14/936,058

(22) Filed: Nov. 9, 2015

Related U.S. Application Data
(60) Provisional application No. 62/076,800, filed on Nov. 7, 2014.

(51) Int. Cl. G07C 13/00; H04L 12/58; G06Q 50/00; G06Q 30/02

(52) U.S. Cl. CPC G07C 13/00; G06Q 30/0207; H04L 51/32; G06Q 50/01

(57) ABSTRACT

A method of and system for obtaining a user response to a query such as a political poll. A query is displayed to a user on a touch screen of a computing device. The computing device detects a finger touch of the user on the touch screen, the finger touch proving a location, a movement vector, an intensity, and a hold time. Then, the computing device determines a user response to the query as a function of the location, the movement vector, the intensity, and the hold time.

### TECHNICAL FIELD

The present invention is a method and system for providing a reward program integrated with a polling system, such as for use political campaigns, commercial surveys and the like.

### BACKGROUND OF THE INVENTION

It is desired to provide a system and methodology that enables to participate in surveys and polls such as political surveys, in which information is sought concerning a variety of topics, such as but not limited to candidates for public office and topics relevant to their candidacy. Often times, surveys are conducted via telephone, which is highly intrusive and provides no incentive for the person being surveyed or polled. Or, a survey may be conducted with people randomly on the streets of a large city. Again, these polls and surveys are intrusive, provide no incentive for a person to participate, and since they are largely anonymous do not provide much insight regarding trends of responses based on demographics and other relevant criteria.

The present invention addresses these problems of the prior art by providing a highly informative and engaging polling ands survey methodology that also gives incentives for participation by using a reward incentive methodology that enables a subscriber to the system to obtain the desired information from the participants on a much more expedient, accurate, informative and timely basis.

### SUMMARY OF THE INVENTION

Thus, provided is a method of and system for obtaining a user response to a query such as a political poll. A query is displayed to a user on a touch screen of a computing device. The computing device detects a finger touch of the user on the touch screen, the finger touch proving a location, a movement vector, an intensity, and a hold time. Then, the computing device determines a user response to the query as a function of the location, the movement vector, the intensity, and the hold time.

The computing device may then send the user response to a survey server computer via a network. In exchange for providing the user response, rewards are then added to a reward account associated with the user as a function of the user response.

The survey server computer may assign a weight to the user response as a function of the status of the user, and it may collate a plurality of weighted user responses that it receives from multiple users.

Optionally, this process may be performed in association with a social network. In this case, profile data of the user may be accessed via the associated social network so that the status of the user is determined via the profile data of the user accessed via the associated social network.

### BRIEF DESCRIPTION OF THE DRAWING

FIG. 1 is a block diagram of the preferred embodiment of the present invention.

FIG. 2 is a flowchart illustrating the methodology of the preferred embodiment of the present invention.

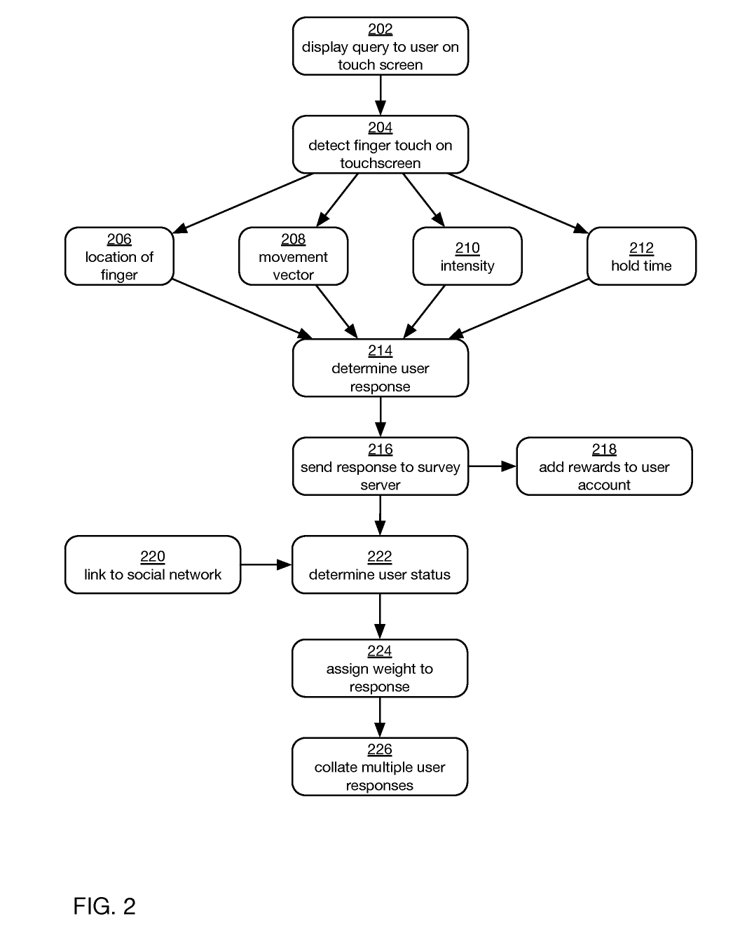

### DETAILED DESCRIPTION OF THE PREFERRED EMBODIMENTS

In the system of the present invention, a participant may earn rewards by answering questions and providing other information that may be useful to a subscriber to the system. The system subscriber is the entity that desires to obtain information from the surveys conducted, such as a political pollster who wishes to determine public opinion about a candidate and relevant topics. The system is implemented preferably using a survey server computer interoperating over a network such as the Internet with a mobile device via an app that may be downloaded onto the device. The app may implement a user input or groups of inputs, which is the mechanism for the participant to provide answers to certain questions and issues that may be raised in the app. This may be referred to as a gamification of politics since the app can measure a participant's position on political issues and choices of candidates through engaging games that earn rewards for the participants.

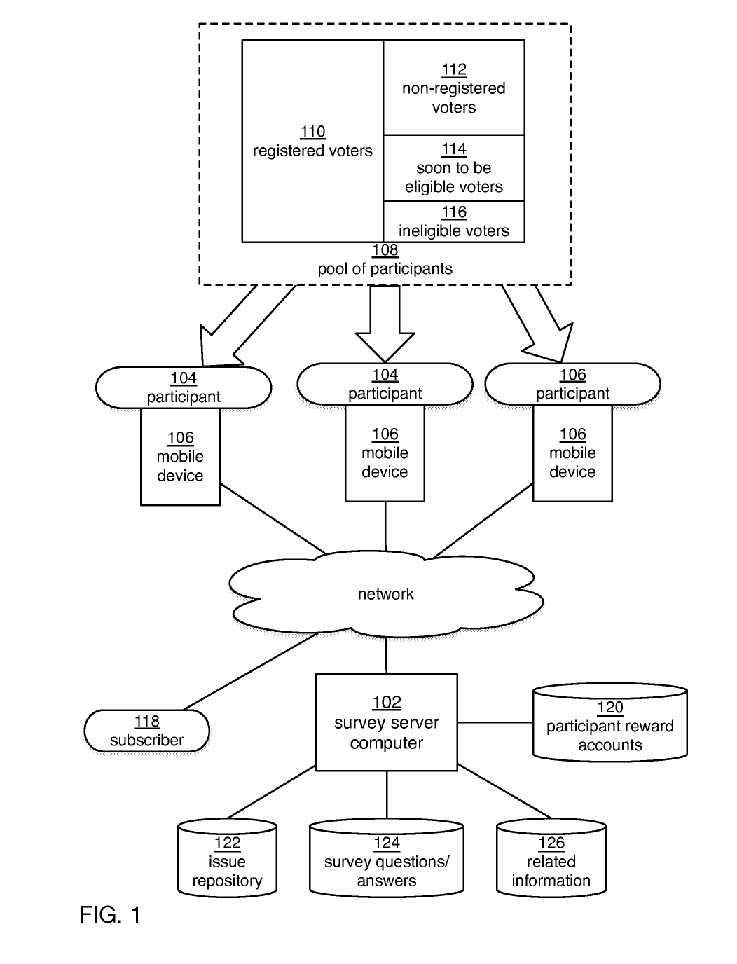

As shown in FIG. 1, the main components of the system are a survey server computer 102, participants 104 in the surveys that interoperate with the survey server computer 102 via a device such as a mobile device 106 (e.g. an IPHONE, IPAD or the like) or desktop or laptop computer, and a subscriber that interoperates with the survey server computer via any type of computing device such as a desktop computer, laptop computer, or mobile device. The mobile device 106 has components and circuitry as well known in the art for accomplishing the objectives set forth herein, including but not limited to means for processing, a touch screen for input and output display functions, and means for wireless communications over a network. These components are well known in the field of computing devices such as mobile devices (e.g. an IPHONE). The pool of possible participants 108 may be logically divided into several sectors, including (but not limited to) registered voters 110, non-registered voters 112, soon to be eligible voters 114, and ineligible voters 116.

The subscriber 118 may specify various criteria for the surveys and polls that it would like to be conducted by the survey server computer of various participants. Depending on the criteria specified by the subscriber, each participant may be given a weight based on which sector he or she may be placed. For example, a subscriber may place a greater weight on the responses provided from a registered voter with respect to an ineligible voter. Or, the subscriber may only be interested in response data from registered voters. This of course may change based on the parameters set forth by the subscriber, and may change amongst different questions and topics in the surveys that are provided. The status of a participant with respect to this classification may be obtained voluntarily (e.g. a questionnaire to the participant) or through other means such as by using data readily available (for example via social networks).

After the participant acquiesces to participating in a survey (which may be part of the terms and conditions of the app after being downloaded), then they are registered into the survey server computer. Optionally, upon registration, the participant may be awarded a set of reward points into a participant reward account at the survey server computer, the use of which may be delayed by a certain time period in order to ensure long term engagement. For example, the participant may be given $50 worth of reward points into his account at registration, which may not be redeemable for six months.

After a participant has registered into the survey server computer and established his reward account 120 for storing earned rewards, then a survey session may be initiated. In a preferred embodiment, a menu of certain issues deemed relevant by the subscriber (and/or the participant or other party to the system) may be presented to the participant on the screen of his mobile device. For example, one issue may be domestic violence, another issue may be foreign relations, another issue may be the world economy, etc. These may be selected from a pool of issues stored in an issue repository such as the database shown in FIG. 1.

Optionally, related information may be presented to the participant that provides background and context to the issue selected. For example, a video related to the issue may be retrieved from the related information database and played on the device, articles may be displayed, a web search on the issue may be automatically invoked, etc. This information may be retrieved from the issue repository 122 or an associated database(s), or it may be retrieved in real time from the Internet based on a search of terms relevant to that issue. For example, if the issue selected is the US economy, information may be presented regarding various politicians' views on how to address the economy, statistics on the economy, etc.

At step 202, the participant will then be asked various questions 124 regarding the selected issue, which may be generic questions applicable to all issues or which may be specific to the issue selected. The participant may be given a list of choices from which to select his answer, or the answer may be in free-form text. For example, a generic question may be
How strongly do you feel that this is an important issue?
   Very strongly
   Moderately strongly
   Not strongly

A specific question may be something such as
Do you feel the US economy is on getting stronger or weaker over the past 12 months?
   Stronger
   No change
   Weaker

The survey questions may be asked before the related background information 126 is presented, after the related background information is presented, or both. When asked before and after, the participant may also be asked if he has changed his mind based on the information presented.

The process may be repeated with respect to a participant over several issues, which may be pre-selected by the subscriber and/or selected by the participant as desired.

As part of the polling process, the present invention implements a paradigm referred to as a pulse meter (or hot button). By selecting the pulse meter on the mobile device, the participant is presented with a screen that enables the user to select, along the continuum of the screen, a level of engagement and/or interest in the issue presented. Various pieces of information may be presented as a background to the screen to provide an integrated and interactive experience. For example, a continuous slider display may be presented that may be selected by the participant. By selecting (pressing) one end of the slider, the participant inputs a strong agreement with an issue, and by pressing the other end of the slider, the participant inputs a strong disagreement with the issue, as the case may be. Of course, since the slider is contiguous, the participant may select any point in the slider to indicate how strongly he may agree or disagree with the issue presented.

A time element may be utilized with the pulse meter. For example, rather than a slider, a simple button may be displayed, and the participant may hold his finger on a selection longer to indicate how strongly he may feel about an issue. As he holds his finger down, the display may change colors in real time (such as by going from blue to red) as a visual feedback of the intensity of the response that is being given. This may operate in conjunction with information being changed on the display that may assist the participant in deciding his viewpoint on an issue. Similarly, with respect to step 204, the touchscreen may be able to detect the intensity of the press of the finger at a given location (e.g. slight touch vs. hard push). In addition to a single button, the time and intensity elements may be input in the slider paradigm as well, to indicate different aspects of his or her response. In this case, location of the finger (206), movement of the finger (208), intensity of the press (210), as well as the amount of time the finger is held on the screen (212) will all signal information regarding the user's response. Thus, the response may be analyzed as a function of these inputs at step 214 as follows:
Response=f(l,m,i,t)
   l=location
   m=movement (e.g. direction and/or speed)
   i=intensity of press
   t=time of holding finger on screen

The survey results, when collated, will give the subscriber insight as to what various participants actually know about an issue, what they don't know about the issue, what they are interested in, what they are not interested in, etc. This information may be collated after being collected from a group of participants (step 226), and may be analyzed geographically (e.g. by state or other geopolitical boundaries). By collating the results of the surveys regarding various topics, great insight may be obtained as to the issues and how they are perceived across various sectors of the population.

The participant may be able to view his or her response graphically, such as on the display screen of the mobile device and/or by printing out a graphical representation of the responses on a printer. The response information may be presented alone or in relationship to responses of others.

This polling methodology is useful for political topics as well as commercial interests, based on the subject matter presented.

As part of the analysis of the survey results provided by the participants, a mathematical value may be generated and assigned to various components of the survey analysis. For example, a set of responses concerning a particular issues may be assigned relative weighting values (step 224) as a function of the demographic, socioeconomic, or other profile characteristics of the participants that have provided those responses. In this case, the subscriber may be interested in survey responses from the Latin-American female demographic; as such, a greater weight is given to those survey responses than for responses from male Caucasians.

The analysis of the survey responses provided by the participants, weighted according to their demographic, socioeconomic or other type of profile, may then be presented to the subscriber graphically, such as in a three dimensional graph that presents survey response as a function of the various profile parameters of the participants in the survey.

The survey methodology of this invention may be implemented as a standalone program on a downloadable app, or it may be integrated with a social network such as FACEBOOK or LINKED IN. This provides access to various profile data regarding the participants (steps 220, 222) such as age, gender, race, occupation, political affiliation, geographical location, etc. It also provides insight as to the opinions of the various participants as they are interconnected with each other through their particular social network of friends or connections, as the case may be.

As mentioned above, each participant may be given an incentive to register in the system and to participate in surveys by awarding reward points to their account that is stored in association with the server computer as shown in FIG. 1. Additional rewards may be provided for responding to various surveys and polls (step 218). By utilizing a reward component with time constraints placed on the ability to redeem those reward points, participants are incentivized to maintain certain levels of participation and longevity in the system.

Additionally, an alert methodology may be implemented whereby participants can be given notifications or alerts on the screens of their mobile device that indicate when new information is available regarding an issue of interest to them. For example, a participant may be previously expressed a strong interest in the issue of domestic violence. When additional information on that topic is available (e.g. a news article or blog post), then a notification is sent to that participant mobile device and pops up on the screen to alert that participant accordingly. That new article may then be pushed to the mobile device for viewing by the participant, who may also be given the ability to modify previous survey responses in if desired. This may be a continuous feedback loop that keeps survey response current and up to date.

What is claimed is:

1. A method of obtaining a user response to a query comprising
displaying to a user a query on a touch screen of a computing device;
the computing device detecting a finger touch of the user on the touch screen, the finger touch proving a location, a movement vector, an intensity, and a hold time; and
the computing device determining a user response to the query as a function of the location, the movement vector, the intensity, and the hold time.

2. The method of claim 1 further comprising the computing device sending the user response to a survey server computer via a network.

3. The method of claim 2 further comprising adding rewards to a reward account associated with the user as a function of the user response.

4. The method of claim 3 further comprising assigning a weight to the user response as a function of the status of the user.

5. The method of claim 4 further comprising collating a plurality of weighted user responses.

6. The method of claim 5 performed in association with a social network.

7. The method of claim 6 further comprising accessing profile data of the user via the associated social network.

8. The method of 7 wherein the status of the user is determined via the profile data of the user accessed via the associated social network.

9. A system comprising a computing device comprising means for processing, a touchscreen, and means for wireless communication over a network, the means for processing programmed to:
display to a user a query on the touch screen of the computing device;
detect a finger touch of the user on the touch screen, the finger touch proving a location, a movement vector, an intensity, and a hold time;
determine a user response to the query as a function of the location, the movement vector, the intensity, and the hold time.

10. The system of claim 9 wherein the means for processing is further programmed to send the user response to a survey server computer via the means for wireless communication over a network.

11. The system of claim 10 wherein the survey server computer adds rewards to a reward account associated with the user as a function of the user response.

12. The system of claim 11 wherein the survey server computer assigns a weight to the user response as a function of the status of the user.

13. The system of claim 12 wherein the survey server computer collates a plurality of weighted user responses.

14. The system of claim 13 wherein the survey server computer is associated with a social network.

15. The system of claim 14 wherein the survey server computer accesses profile data of the user via the associated social network.

16. The system of 15 wherein the survey server computer determines the status of the user user via the profile data of the user accessed via the associated social network.
